(19) United States
(12) Patent Application Publication
(10) Pub. No.: US 2025/0192618 A1
(43) Pub. Date: Jun. 12, 2025

(54) MULTI-FORM WIRELESS CHARGING DEVICE

(71) Applicant: INVISIBLE TECHNOLOGY (SHEN ZHEN) CO., LTD., Shenzhen (CN)

(72) Inventor: Tong Jiang, Shenzhen (CN)

(21) Appl. No.: 18/401,374

(22) Filed: Dec. 30, 2023

(30) Foreign Application Priority Data
Dec. 8, 2023 (CN) 202323367770.3

(51) Int. Cl. H02J 50/40; H02J 7/00; H02J 50/00; H02J 50/10

(52) U.S. Cl. CPC H02J 50/402; H02J 7/0044; H02J 50/005; H02J 50/10

(57) ABSTRACT

The utility model provides a multi-form wireless charging device. The multi-form wireless charging device includes a first wireless charging module, a second wireless charging module, and a third wireless charging module. Side edges of the first wireless charging module and the second wireless charging module are beveled edges, and are connected through a rotating device, to enable the first wireless charging module and the second wireless charging module to present a plurality of postures by rotating. The third wireless charging module is rotationally connected to the first wireless charging module through a hinge. The utility model has the following beneficial effects.

### TECHNICAL FIELD

The utility model relates to the field of wireless chargers, and in particular to a multi-form wireless charging device.

### BACKGROUND

As wireless charging is widely used, a wireless charging mobile phone, a wireless charging watch, a wireless charging headset, and another small electronic product appear. An existing wireless charger has a single structure, resulting in a single-use scenario. Therefore, the existing wireless charger is not used in a plurality of scenarios.

For example, when a user needs to simultaneously charge a plurality of electronic products, electronic products may only be charged in sequence, without being simultaneously charged. A charging form of a charging base is single, either a wireless charging base similar to a charging table, or a vehicle-mounted clamping type wireless charging base, and a device for wireless charging of different devices is not available. Therefore, wireless charging does not be simultaneously performed on different devices.

### SUMMARY

To overcome defects in the prior art, the utility model provides a multi-form wireless charging device, to meet a requirement of being used in a plurality of charging scenarios, and simultaneously charge one or more electronic products such as a mobile phone, a watch, and a headset through the following technical solution.

A multi-form wireless charging device includes a first wireless charging module, a second wireless charging module, and a third wireless charging module. Side edges of the first wireless charging module and the second wireless charging module are beveled edges, and are connected through a rotating device, to enable the first wireless charging module and the second wireless charging module to present a plurality of postures by rotating. The third wireless charging module is rotationally connected to the first wireless charging module.

Further, the first wireless charging module and the second wireless charging module axially rotate along the beveled edges through the rotating device, to enable the first wireless charging module and the second wireless charging module to be located in a same plane or at a specific angle.

Further, the rotating device includes a rotary shaft, a rotary shaft fixing member, and limiting members. The rotating device is located on the side edge of the first wireless charging module or the second wireless charging module, and the rotary shaft fixing member is connected to the rotary shaft, to enable the first wireless charging module or the second wireless charging module to rotate along the rotating device.

Further, the limiting member is used to limit a rotation angle of the rotary shaft, to enable the first wireless charging module and the second wireless charging module to be in parallel or at a specific angle.

Further, an angular value of an inner angle of the beveled edges of the first wireless charging module and second wireless charging module is an acute angle less than 90°.

Further, the third wireless charging module and the second wireless charging module are connected through a hinge or a shaft.

Further, the third wireless charging module is stowed in an accommodation groove of the second wireless charging module.

Further, a positional relationship between the third wireless charging module and the second wireless charging module may be replaced: the third wireless charging module and the second wireless charging module are located in a same plane.

The utility model has the following beneficial effects: The wireless charging module in a rotary charging device provides a plurality of structural forms, and functions are different in different forms. Therefore, the multi-form wireless charging device can be used in a plurality of wireless charging scenarios.

### BRIEF DESCRIPTION OF THE DRAWINGS

FIG. 1 is a schematic diagram of a structure of a first form of a wireless charging device according to a first embodiment of the utility model;

FIG. 2 is a schematic diagram of a structure of a back of a wireless charging device according to a first embodiment of the utility model;

FIG. 3 is a schematic diagram of a structure of a third form of a wireless charging device according to a first embodiment of the utility model;

FIG. 4 is a schematic diagram of a structure of a back of a third form of a wireless charging device according to a first embodiment of the utility model;

FIG. 5 is a schematic diagram of a decomposed structure of modules of a wireless charging device according to a first embodiment of the utility model;

FIG. 6 is a schematic diagram of a back of a decomposed structure of modules of a wireless charging device according to the utility model;

FIG. 7 is a schematic diagram of an exploded structure of a wireless charging device according to a first embodiment of the utility model; and

FIG. 8 is a schematic diagram of a structure of a wireless charging device according to a second embodiment of the utility model.

### REFERENCE NUMERALS

first wireless charging module 10; second wireless charging module 20; third wireless charging module 30; first charging table 11; first beveled edge 12; rotary shaft 13; limiting hole 14; through hole 15; circuit board 16; first coil 17; charging interface 18; second charging table 21; second beveled edge 22; rotary shaft fixing member 23; limiting blocks 24; accommodation groove 25; shaft hole 26; wire holes 27, 33; second coil 28, second coil bracket 29; third charging table 31; limiting rotary shaft 32; third coil bracket 34; control board 35.

### DESCRIPTION OF EMBODIMENTS

The technical solutions in embodiments of the present disclosure are clearly and completely described below with reference to the accompanying drawings in the embodiments of the present disclosure. Apparently, the described embodiments are merely a part rather than all of the embodiments of the present disclosure.

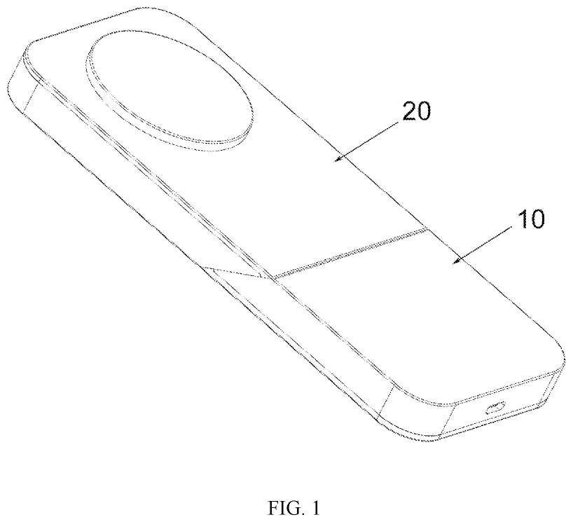

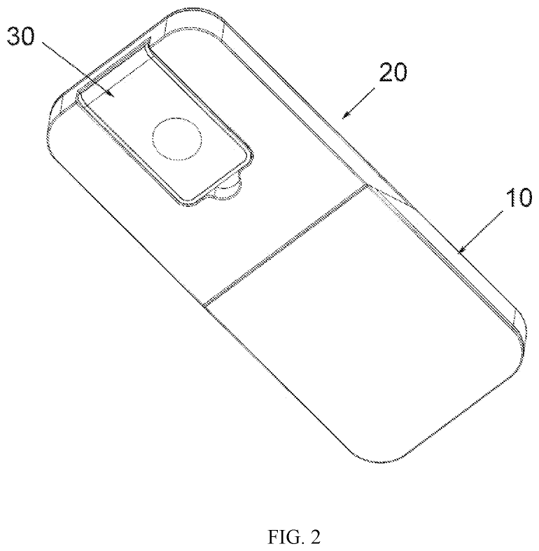

Refer to FIG. 1 to FIG. 4. A multi-form wireless charging device includes a first wireless charging module 10, a second wireless charging module, and a third wireless charging module. Side edges of the first wireless charging module and the second wireless charging module are beveled edges (12, 22), and are connected through a rotating device, to enable the first wireless charging module and the second wireless charging module to present a plurality of postures by a rotating angle. The third wireless charging module is rotationally connected to the first wireless charging module.

The first wireless charging module and the second wireless charging module axially (an axial direction of a rotary shaft 13) rotate along the beveled edges through the rotating device, to enable the first wireless charging module and the second wireless charging module to be located in a same plane or at a specific angle.

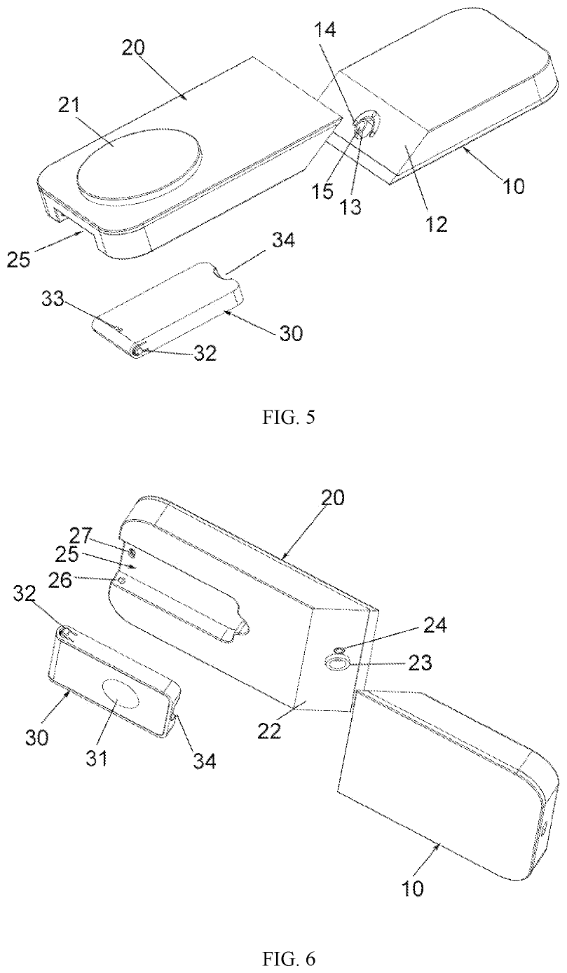

Refer to FIG. 5 and FIG. 6. The rotating device includes a rotary shaft 13, a rotary shaft fixing member 23, and limiting members (24, 14). The rotary shaft 13 is located on a side edge of the first wireless charging module or the second wireless charging module, and accordingly, the rotary shaft fixing member 23 is located on the side edge of the second wireless charging module or the first wireless charging module. The rotary shaft fixing member 23 is connected to the rotary shaft 13. After the rotary shaft is connected to the rotary shaft fixing member, the first wireless charging module or the second wireless charging module may rotate along the rotary shaft, to enable one of the first wireless charging module or the second wireless charging module to axially rotate along the rotary shaft by a specific angle.

A through hole 15 is provided a center of the rotary shaft 13. A conductor passes through the through hole to connect a circuit board of the first wireless charging module to a coil inside the second wireless charging module.

The other end of the first wireless charging module 10 is provided with a charging interface 18, for example, a type C interface. The charging interface is used to connect an adapter, to obtain a current input.

The limiting members 24 are used to limit the rotation angle of the rotary shaft. The rotation angle of the rotary shaft is 0°, 90°, or 180°. Three limiting holes are provided at corresponding positions on a first beveled edge. Included angels between a connection line from three limiting holes each to an axis of the rotary shaft and a horizontal plane is 0°, 90°, or 180°. Therefore, the first wireless charging module and the second wireless charging module are enabled to be in parallel or at a specific angle. An angular value is related to an angle of the beveled edge.

A first beveled edge 12 of the first wireless charging module 10 and a second beveled edge 22 of the second wireless charging module 20 are connected in contact. The rotating device is disposed between the first beveled edge 12 and the second beveled edge 22. When the first wireless charging module 10 rotates along the rotary shaft, the first beveled edge 12 is in contact with the second beveled edge 22.

In a third form, an included angle between the first wireless charging module 10 and the second wireless charging module 20 is a sum of angular values of the beveled edge of the first wireless charging module and the beveled edge of the second wireless charging module, and a sum of an inner angle of the first beveled edge 12 and an inner angle of the second beveled edge 22.

The angular value of the beveled edge of the first wireless charging module and the angular value of the beveled edge of the second wireless charging module are acute angles less than 90°.

When the rotary shaft does not rotate or rotates by 180°, the first wireless charging module and the second wireless charging module are located in a same plane. When the rotary shaft rotates by 90°, the first wireless charging module and the second wireless charging module are at a specific angle.

In the utility model, when the first wireless charging module and the second wireless charging module are located in the same plane, the wireless charging device is in a first form. When the first wireless charging module and the second wireless charging module are at the specific angle, the wireless charging device is in a second form.

The first wireless charging module 10 has a first charging table 11. The first charging table 11 is used to charge a small and micro device. The second wireless charging module 20 has a second charging table 21. The second charging table 21 is used to charge a mobile phone. The third wireless charging module has a third charging table 22. The third charging table 22 is used to charge a watch and a bracelet.

As shown in FIG. 1 and FIG. 8, in use, in the first form, the first wireless charging module is horizontally placed on a desk, the mobile phone is flatly placed on the device, and the second wireless charging module charges the mobile phone.

In the second form, the first wireless charging module 10 is horizontally placed on the desk, the second wireless charging module 20 and the horizontally placed first wireless charging module are at the specific angle, to enable the mobile phone to lean against a surface of the second wireless charging module for wireless charging. A headset with a wireless charging function is placed on a surface of the first wireless charging module for wireless charging simultaneously. The device can simultaneously perform wireless charging on the mobile phone and the headset.

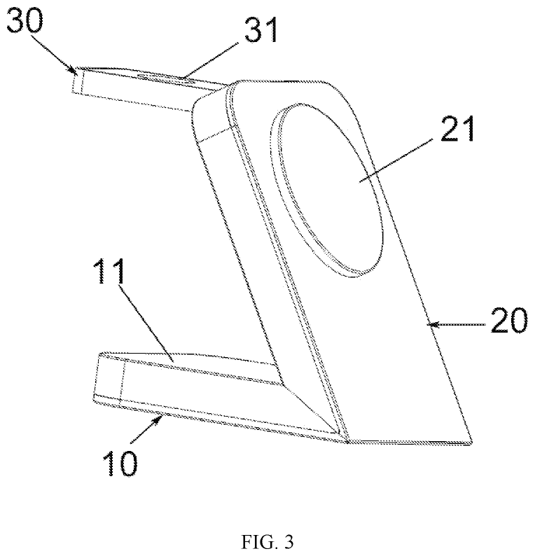

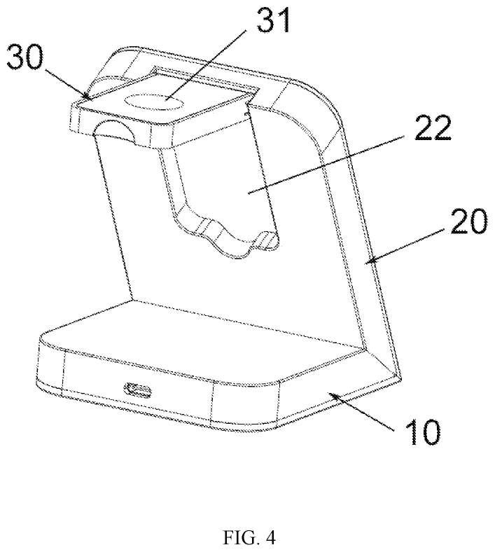

In an embodiment of the utility model, as shown in FIG. 3 and FIG. 4, in the third form, the third wireless charging module 30 is unfolded, that is, the third wireless charging module is unfolded along the rotary shaft. The third wireless charging module is placed in parallel to a first charging module, to hang the watch on the third charging table 31 of the third wireless charging module for wireless charging.

The third wireless charging module 30 is accommodated in the second wireless charging module, and rotates to unfold along the rotary shaft if necessary.

A combination part of the second wireless charging module 20 and the third wireless charging module 30 may be provided with wire holes (27, 33). The wire holes (27, 33) are provided at corresponding locations on a housing, and used to connect a circuit board and the coil.

In another embodiment of the utility model, the through hole may further be provided in the center of the limiting rotary shaft, and a wire passes through the through hole.

As shown in FIG. 5 and FIG. 6, a limiting rotary shaft 32 is oppositely disposed on two side edges of a third charging module. A section of the limiting rotary shaft is semicircular. A defective portion is disposed at an end of the section. An elastic limiting member is disposed at a corresponding position of the second charging module. When the defective portion rotates the limiting member, the limiting member springs and restricts the defective portion from rotating, to implement a limiting function.

The limiting method has a plurality of replacement structures, which is not detailed here.

As shown in FIG. 1 and FIG. 8, when the first wireless charging module, the second wireless charging module, and the third wireless charging module are placed in parallel, the wireless charging device is constituted as a wireless charger that may be placed in parallel on the desk, and may be used in a general wireless charging scenario.

When the mobile phone and the headset need to be simultaneously charged, components of the device are rotated and deformed, to switch to the second form. In this case, the mobile phone leans against the second charging module, and the headset is placed on a charging base of the first wireless charging module. A schematic diagram of the second form is not shown in the accompanying drawings.

As shown in FIG. 3 and FIG. 4, the mobile phone, the headset, and the watch need to be simultaneously charged, the device is deformed and switched to the third form. On the basis of the foregoing application, the watch is hung on the third wireless charging module for charging. In this case, the mobile phone, the headset, and the watch are simultaneously charged.

In practical application, the first charging module may further charge a ring or finger ring with a wireless charging function. The third charging module may charge a health bracelet, which is not listed in detail here.

According to the utility model, a structure is cleverly designed. The structure can be switched to different forms, to meet different wireless charging scenarios. In addition, the form may be simply switched by rotating only one of the modules.

As shown in FIG. 8, in a second embodiment of the utility model and based on the first embodiment, the third wireless charging module and the second wireless charging module are connected through a hinge, to enable the third wireless charging module 30, the second wireless charging module 20, and the first wireless charging module 10 to be in parallel, and enable the third charging table, the second charging table, and the first charging table to be located in the same plane. The third charging module shown in FIG. 3 and FIG. 4 may be switched by rotating the second wireless charging module and the third charging module.

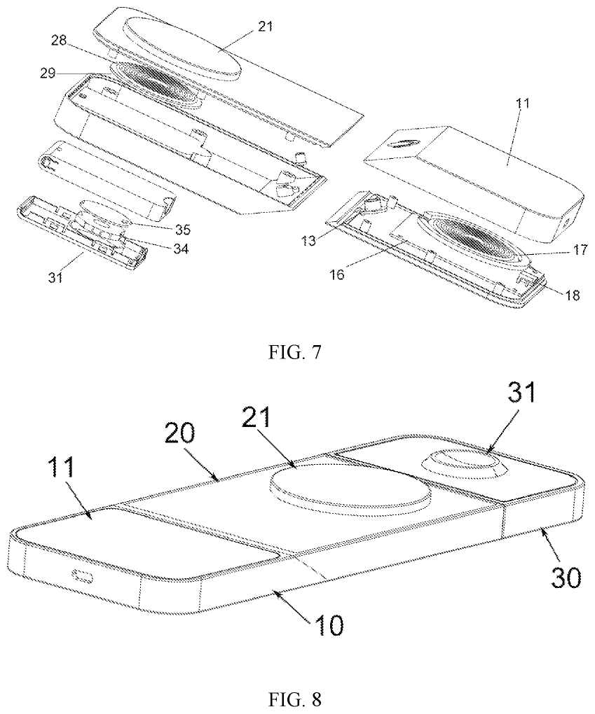

As shown in FIG. 7, the first wireless charging module 10, the second wireless charging module 20, and the third wireless charging module 30 each include a housing, a circuit board, and a coil. In the embodiment of the utility model, a circuit board 16 is disposed in the first charging module 10, while no circuit board is disposed in the second wireless charging module and the third wireless charging module, to reduce costs. The circuit board 16 may simultaneously control a first coil 17, a second coil 28, and a third coil (not shown in the figure).

A control board 35 may be disposed in the third wireless charging module 30, to assist in controlling the third coil with the circuit board 16.

The circuit board 16 mainly includes a master control chip, a driver chip, a power device (MOS), a resistor-capacitor, and a PCB board. The coil is generally a standard coil. Relevant wireless charging standards strictly specify a structural dimensional parameter of the coil. For a structure of the wireless charging module, refer to existing technologies. The wireless charging module supports a plurality of fast charging input protocols, namely, QC3.0/QC2.0/PD3.0+PPS, and supports a plurality of output power, namely, 15 W/10 W/7.5 W/5 W.

The above merely describes specific examples of the utility model, but the protection scope of the utility model is not limited thereto. A person skilled in the art can easily conceive modifications or replacements according to the technical solutions and ideas of the utility model within the technical scope of the utility model, and these modifications or replacements shall fall within the protection scope of the utility model.

1. A multi-form wireless charging device, comprising a first wireless charging module, a second wireless charging module, and a third wireless charging module, wherein side edges of the first wireless charging module and the second wireless charging module are beveled edges, and are connected through a rotating device, to enable the first wireless charging module and the second wireless charging module to present a plurality of postures by rotating, and the third wireless charging module is rotationally connected to the first wireless charging module.

2. The multi-form wireless charging device according to claim 1, wherein the first wireless charging module and the second wireless charging module axially rotate along the beveled edges through the rotating device, to enable the first wireless charging module and the second wireless charging module to be located in a same plane or at a specific angle.

3. The multi-form wireless charging device according to claim 2, wherein the rotating device comprises a rotary shaft, a rotary shaft fixing member, and limiting members, the rotating device is located on the side edge of the first wireless charging module or the second wireless charging module, and the rotary shaft fixing member is connected to the rotary shaft, to enable the first wireless charging module or the second wireless charging module to rotate along the rotating device.

4. The multi-form wireless charging device according to claim 3, wherein the limiting member is used to limit a rotation angle of the rotary shaft, to enable the first wireless charging module and the second wireless charging module to be in parallel or at a specific angle.

5. The multi-form wireless charging device according to claim 4, wherein an angular value of an inner angle of the beveled edges of the first wireless charging module and second wireless charging module is an acute angle less than 90°.

6. The multi-form wireless charging device according to claim 1, wherein the third wireless charging module and the second wireless charging module are connected through a hinge or a shaft.

7. The multi-form wireless charging device according to claim 6, wherein the third wireless charging module is stowed in an accommodation groove of the second wireless charging module.

8. The multi-form wireless charging device according to claim 7, wherein a positional relationship between the third wireless charging module and the second wireless charging module may be replaced: the third wireless charging module and the second wireless charging module are located in a same plane.
